(19) United States
(12) Patent Application Publication
(10) Pub. No.: US 2022/0022201 A1
(43) Pub. Date: Jan. 20, 2022

(54) METHODS FOR MULTIPLE COMMUNICATIONS BETWEEN A WIRELESS DEVICE AND A PLURALITY OF NETWORK NODES, RELATED WIRELESS DEVICES AND RELATED NETWORK NODES

(71) Applicant: Sony Corporation, Tokyo (JP)

(72) Inventors: Anders MELLQVIST, Malmö (SE); Svante ALNAS, Lund (SE)

(21) Appl. No.: 17/414,290

(22) PCT Filed: Dec. 12, 2019
(86) PCT No.: PCT/SE2019/051271

§ 371 Date: Jun. 15, 2021

(30) Foreign Application Priority Data
Jan. 16, 2019 (SE) 1950050-3

(51) Int. Cl. H04W 72/12; H04W 76/15

(52) U.S. Cl. CPC H04W 72/12; H04W 74/0833; H04W 76/15

(57) ABSTRACT

The present disclosure provides a method, performed in a wireless device, for multiple communications between the wireless device and a plurality of network nodes of a plurality of networks, the plurality of network nodes comprising a first network node of a first network and a second network node of a second network. The wireless device comprises a wireless interface with a single radio transceiver configured to communicate with the first network node and the second network node. The method comprises determining a first time pattern parameter indicative of a first communication with the first network node, and a second time pattern parameter indicative of a second communication with the second network node. The method comprises requesting via the single radio transceiver, to the first network node that the first communication is scheduled based on the first time pattern parameter. The method comprises requesting via the single radio transceiver, to the second network node that the second communication is scheduled based on the second time pattern parameter.

The present disclosure pertains to the field of wireless communications. More specifically, the present disclosure relates to methods for multiple communications between the wireless device and a plurality of network nodes of a plurality of networks, related wireless devices and related network nodes.

### BACKGROUND

A wireless device may need to connect to two different networks for different use cases. This is demonstrated by the existence and the increasing market size of phones with support for dual subscriber identity module, SIM.

The 3^{rd} generation partnership project, 3GPP, standard requires the wireless device to synchronize with a network and a network node of the network assigns different time-slots to the wireless device to transmit and listen in. The network node decides when the wireless device should transmit and listen.

When a wireless device with dual SIM is used, the wireless device is capable of connecting to a first operators' network and a second operators' network at different periods of time. However, the first operators' network and the second operators' network are not synchronized so when the wireless device communicates with a network node of the first operators' network, the wireless device ignores the second operators' network. To the second operators' network, it appears as if the wireless device is out of coverage for the duration of the communication with the first network. This leads to a waste of radio resources in e.g. the second operators' network in this example.

There is a need for improving multiple communications between the wireless device and a plurality of networks.

### SUMMARY

Accordingly, there is a need for wireless devices, network nodes and methods, which alleviate, mitigate and address the shortcomings of the 3GPP standard for multiple communications with plurality of networks.

The present disclosure provides a method, performed by a wireless device, for multiple communications between the wireless device and a plurality of network nodes of a plurality of networks, the plurality of network nodes comprising a first network node of a first network and a second network node of a second network. The wireless device comprises a wireless interface with a single radio transceiver configured to communicate with the first network node and the second network node. The method comprises determining a first time pattern parameter indicative of a first communication with the first network node, and a second time pattern parameter indicative of a second communication with the second network node. The method comprises requesting via the single radio transceiver, to the first network node that the first communication is scheduled based on the first time pattern parameter. The method comprises requesting via the single radio transceiver, to the second network node that the second communication is scheduled based on the second time pattern parameter.

The present disclosure provides a wireless device comprising a memory module, a processor module, and a wireless interface comprising a radio transceiver, wherein the wireless device is configured to perform any of the methods disclosed herein.

The present disclosure provides a computer readable storage medium storing one or more programs, the one or more programs comprising instructions, which when executed by a wireless device cause the wireless device to perform any of the methods disclosed herein.

It is an advantage of the present disclosure that according to one or more embodiments, the wireless device may benefit from an improved scheduling of communications to several networks using a single radio transceiver at the wireless device so that the wireless device can communicate with several networks in sequence.

Further, the present disclosure provides a method performed by a network node. The method comprises receiving from a wireless device, a request comprising a time pattern parameter indicative of a communication with the wireless device. The method comprises scheduling the communication with the wireless device based on the time pattern parameter.

The present disclosure provides a network node comprising a memory module, a processor module, and a wireless interface, wherein the network node is configured to perform any of the methods disclosed herein.

The present disclosure provides a computer readable storage medium storing one or more programs, the one or more programs comprising instructions, which when executed by a network node cause the network node to perform any of the methods disclosed herein.

Further, this may advantageously lead to the network nodes being capable of scheduling procedures in the control plane and the user plane to match the active periods in the time pattern of the wireless devices. This further may avoid waste of radio resources on periods where a wireless device plans to communicate with another network node of another network and thereby provide an optimization of the radio resources at the network node. The network node disclosed herein is advantageously capable of scheduling both downlink traffic to the wireless device and scheduling available resource blocks for the wireless device to transmit uplink traffic according to the time pattern parameter.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary wireless communication system comprising an exemplary network node and an exemplary wireless device according to this disclosure,

FIG. 2 is a flow-chart illustrating an exemplary method, performed by a wireless device, for multiple communications with network nodes from a plurality of networks according to this disclosure,

FIG. 3 is a flow-chart illustrating an exemplary method, performed by a network node of a wireless communication system according to this disclosure,

FIG. 4 is a block diagram illustrating an exemplary wireless device according to this disclosure, and

FIG. 5 is a block diagram illustrating an exemplary network node according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

When a wireless device with single transceiver and dual SIM is used, the wireless device is capable of connecting a first network and a second network at different periods of time. However, the first network and the second network are not synchronized so timeslots scheduled in each network for the wireless device to transmit or listen in may not be optimal.

The 3GPP standard does not allow the wireless device to inform the network node when the wireless device is available to transmit to the network node. For example, existing “dual SIM, single radio” products can only communicate actively with one network at a time. Since the networks are not “dual SIM aware”, there is no way for a wireless device to signal to a first network that the wireless device plans to communicate actively with a second network for a time period. From the point of view of the first network, the wireless device just disappears as if the wireless device went out of coverage. The first network ends up wasting radio resources in un-necessarily paging the wireless device in a cell where the wireless device was last seen and in adjacent cells and finally after long time deregistering the wireless device.

The present disclosure proposes in one or more embodiments to address shortcomings of the 3GPP standard mentioned herein.

The figures are schematic and simplified for clarity, and they merely show details which are essential to the understanding of the invention, while other details have been left out. Throughout, the same reference numerals are used for identical or corresponding parts.

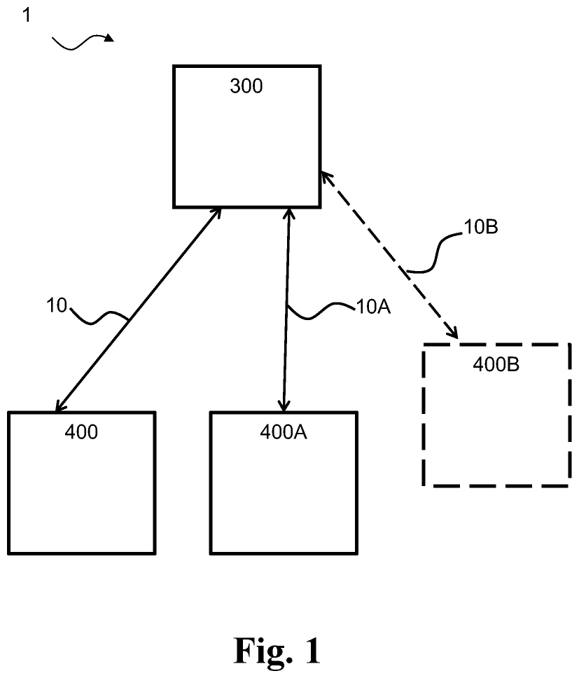

FIG. 1 is a diagram illustrating an exemplary wireless communication system 1 comprising an exemplary first network node 400 of a first network, an exemplary second network node 400A of a second network and an exemplary wireless device 300 according to this disclosure. The first network node may be different from the second network node. For example, the first network may be controlled by a first operator different from a second operator controlling the second network.

As discussed in detail herein, the present disclosure relates to a wireless communication system 1 comprising a cellular system, e.g. a 3GPP wireless communication system. The wireless communication system 1 comprises a wireless device 300, a first network node 400, a second network node 400A and optionally a third network node 400B of a third network. The third network may be different from the first network and/or the second network. For example, the third network may be controlled by a third operator different from a first and/or second operator controlling the first and/or second network respectively.

A network node disclosed herein (e.g. a first network node, and/or a second network node) refers to a radio access network node operating in the radio access network, such as a base station, and/or an evolved Node B, eNB, gNB.

The wireless communication system 1 described herein may comprise one or more wireless devices 300 and/or a plurality of network nodes 400, 400A, 400B such as one or more of: a base station, an eNB, a gNB and/or an access point, wherein each network node may belong to a different network.

A wireless device may comprise mobile device and/or a user equipment, UE.

The wireless device 300 is configured to communicate with the first network node 400 via a wireless link (or radio access link) 10. The wireless device 300 is configured to communicate with the second network node 400A via a wireless link (or radio access link) 10A. The wireless device 300 may be configured to communicate with the third network node 400B via a wireless link (or radio access link) 10B.

The wireless device 300 is configured to perform one or more first communications with the first network node 400 via a wireless link (or radio access link) 10. The wireless device 300 is configured to perform one or more second communications with the second network node 400A via a wireless link (or radio access link) 10A. The wireless device 300 may be configured to perform one or more third communications with the third network node 400B via a wireless link (or radio access link) 10B.

The wireless device 300 is configured to carry out the first communications according to a first subscription with the first network. The wireless device 300 is configured to carry out the second communications according to a second subscription with the second network. The wireless device 300 is configured to carry out the first communications using a first SIM comprised in the wireless device 300. The wireless device 300 is configured to carry out the second communications using a second SIM comprised in the wireless device 300.

The wireless device 300 may comprise a single radio transceiver capable of maintaining active connections to two networks simultaneously, e.g. to the first network node 400 and to the second network node 400A.

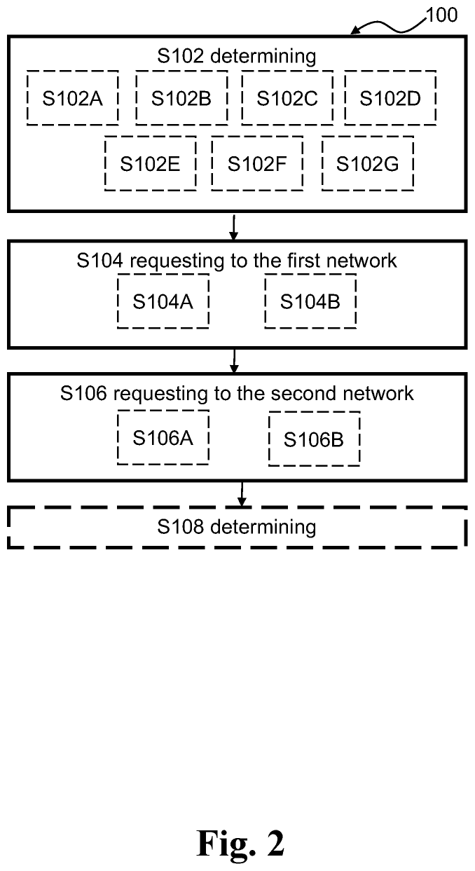

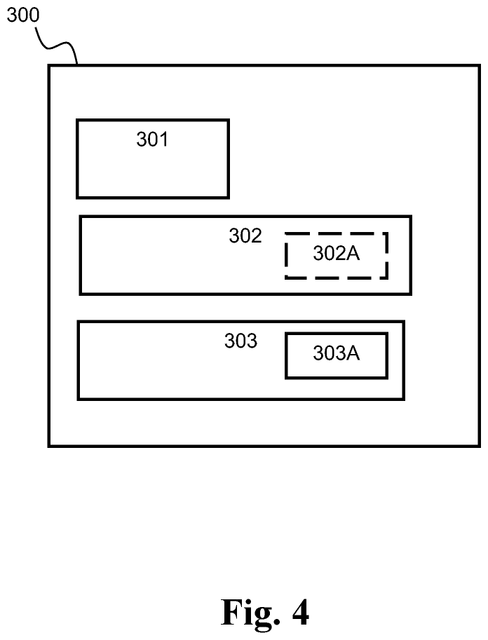

FIG. 2 shows a flow-chart illustrating an exemplary method 100, performed by a wireless device (e.g. the wireless device discloses herein, such as wireless device 300 of FIGS. 1 and 4).

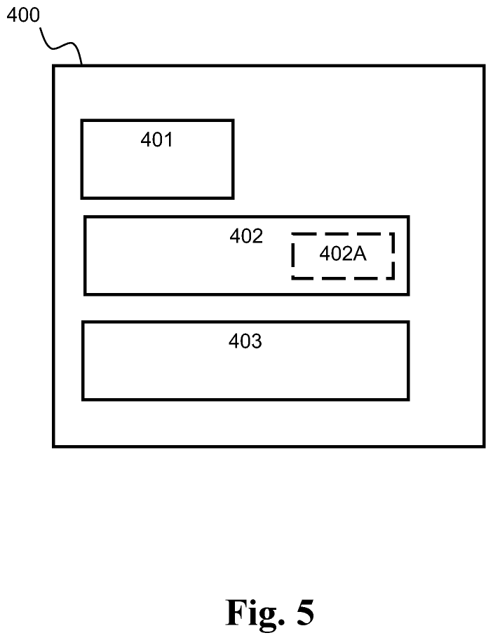

Method 100 is performed by a wireless device, for multiple communications between the wireless device and a plurality of network nodes of a plurality of networks (as illustrated in FIG. 1). The plurality of network nodes may be from a plurality of networks. The plurality of network nodes comprises a first network node (e.g. network node 400 of FIGS. 1 and 5) of a first network and a second network node (e.g. network node 400A of FIG. 1) of a second network. The first network is different from the second network. For example, the first network may be controlled by a first operator different from a second operator controlling the second network.

The wireless device comprises a wireless interface with a single radio transceiver configured to communicate with the first network node and the second network node. The single radio transceiver may be configured to communicate with at least two network nodes of the plurality of network nodes (e.g. to maintain simultaneously or in parallel active connections to a plurality of network nodes belonging to different networks). The single radio transceiver may be configured to communicate with the first network node and the second network node.

The method 100 comprises determining S102, a first time pattern parameter indicative of a first communication with the first network node, and a second time pattern parameter indicative of a second communication with the second network node.

In one or more exemplary methods, a time pattern parameter (e.g. the first time pattern parameter and/or the second time pattern parameter) indicative of a communication may comprise a parameter indicative of a time pattern comprising an active time period which is for the communication from the wireless device to the corresponding network node involved the communication, and an inactive time period where no communication is planned between the wireless device and the corresponding network node. For example, a first time pattern associated with the first network may be a repetition of the following pattern: an active time period T1 followed by an inactive period T2, resulting in e.g. T1-T2-T1-T2-T1-T2 while for the second network, the wireless device may use a second time pattern associated with the second network: a repetition of the following pattern: an active time period T2 followed by an inactive period T1, resulting in e.g. T1-T2-T1-T2-T1-T2. The time pattern parameter may be seen as a non-overlapping time pattern parameter that is determined to avoid an overlap between the time slots for the first communication with the time slots for the second communication. For example, the wireless device may determine for each network node a non-overlapping time pattern parameter so as to e.g. communicate the time pattern parameter to the corresponding network node. For example, when the wireless device plans 70% of a time period to be carrying out the first communication and 20% of the time period to be carrying out the second communication, the wireless device may determine a first time pattern parameter indicating: 70 ms of active time period with the first network node followed by optionally: 5 ms buffer time, and 25 ms of inactive time period (to accommodate 20 ms for the second communication).

The method 100 comprises requesting S104, via the single radio transceiver, to the first network node that the first communication is scheduled based on the first time pattern parameter. In one or more exemplary methods, requesting S104 to the first network node that the first communication is scheduled based on the first time pattern parameter comprises generating S104A a first request comprising the first time pattern parameter. In one or more exemplary methods, requesting S104 to the first network node that the first communication is scheduled based on the first time pattern parameter comprises transmitting S104B via the single radio transceiver, the first request to the first network node.

The method 100 comprises requesting S106, via the single radio transceiver, to the second network node that the second communication is scheduled based on the second time pattern parameter. In one or more exemplary methods, requesting S106 to the second network node that the second communication is scheduled based on the second time pattern parameter comprises generating S106A a second request comprising the second time pattern parameter. In one or more exemplary methods, requesting S106 to the second network node that the second communication is scheduled based on the second time pattern parameter comprises transmitting S106B, via the single radio transceiver, the second request to the second network node.

This may advantageously lead to enabling an improved scheduling of communications to several networks using a single radio transceiver at the wireless device so the wireless device can communicate with several networks in sequence.

In one or more exemplary methods, requesting S104 and/or S106 may be performed after paging. In one or more exemplary methods, requesting S104 and/or S106 may be performed as part of registration or in the UE triggered service request of the wireless device with the first network node and/or the second network node respectively. In one or more exemplary methods, requesting S104 and/or S106 may be performed periodically (e.g. every hour and every day). It is to be noted that the first network and the second network may drift in time compared to one another, so the wireless device may perform S104 and/or S106 periodically (e.g. frequently or very frequently) or in response to a triggering event to report an updated time pattern parameter when available.

In one or more exemplary methods, determining S102 the first time pattern parameter indicative of the first communication with the first network node is performed S102A based on a type of service of the first communication. In one or more exemplary methods, determining S102 the second time pattern parameter indicative of the second communication with the second network node is performed S102B based on a type of service of the second communication. In other words, determining S102 the first time pattern parameter indicative of the first communication with the first network node may comprise determining S102A the first time pattern parameter indicative of the first communication with the first network node based on a type of service of the first communication. In one or more exemplary methods, a type of service (e.g. of the first communication) may comprise a type of data, and/or a type of services associated with the corresponding subscription of the wireless device to the corresponding network. Examples of types of service include one or more of: a telephony service type, a multi-media service type, a streaming service type, a best-effort (e.g. browsing, emailing, messaging) service type, and a low latency service type. In one or more exemplary methods, a type of service (e.g. of the first communication) may comprise on a QoS parameter for supporting the service associated with the first communication. For example, the first time pattern parameter and/or second time pattern parameter may be determined based on a QoS parameter for supporting the service associated with the first communication. This may advantageously allow meeting the QoS requirements in terms of QoS metrics (such as latency, throughput, and/or jitter) associated with the first communication. When a subscription provides for both a general data service and a telephony service, the present disclosure permits, according to one or more embodiments, to dynamically adapt based on the use case, e.g. based on requirements to support the service, e.g. based on QoS metrics.

For example, the present disclosure allows, in one or more embodiments, to support the wireless device in utilizing e.g. the first and second networks in sequence during the same time window to e.g. watch a movie on the Internet and have a phone call with different operators, which appears to be “at the same time” for a user of the wireless device, by adjusting a size of timeslots assigned to the wireless device. A size of the timeslots is to be determined according to an expected latency to support a service. For example, 5 seconds timeslots per network does not support a phone call that requires shorter latency while on the other hand very small timeslots may require larger buffer size between the two networks. When the usage of the service is changed, for example receiving a phone call while streaming a video then this may also require reporting of an updated time pattern parameter to the corresponding network node.

In one or more exemplary methods, determining S102 the first time pattern parameter indicative of the first communication with the first network node is performed S102C based on a random access control channel, RACH, parameter of the first communication. In one or more exemplary methods, a random access control channel, RACH, parameter may indicate one or more time slots used for carrying out the random access procedure with a corresponding network node. The first time pattern parameter may be determined to accommodate for the wireless device to perform the RACH procedure with the first network node. It may be envisaged as advantageous that the wireless device is configured to determine a time pattern that accommodates RACH for both the first and the second network.

In one or more exemplary methods, determining S102 the second time pattern parameter indicative of the second communication with the second network node is performed S102D based on a random access control channel, RACH, parameter of the second communication. The second time pattern parameter may be determined to accommodate for the wireless device to perform the RACH procedure with the second network node.

In one or more exemplary methods, determining S102 the first time pattern parameter indicative of the first communication with the first network node is performed S102E based on a paging occasion of the first communication. In other words, determining S102 the first time pattern parameter indicative of the first communication with the first network node may comprise determining S102E the first time pattern parameter indicative of the first communication with the first network node based on a paging occasion of the first communication. Stated differently, the first time pattern parameter may be determined to include or take into account the paging occasion scheduled by the first network node. For example, the wireless device may determine the first time pattern parameter to characterize a time pattern which coincides active time periods with one or more paging slots allocated to the wireless device from the first network node or the first network node is configured to schedule the paging slots to match the active periods characterized by the first time pattern parameter.

In one or more exemplary methods, determining S102 the second time pattern parameter indicative of the second communication with the second network node is performed S102F based on a paging occasion of the second communication. In other words, determining S102 the second time pattern parameter indicative of the second communication with the second network node may comprise determining S102F the second time pattern parameter based on a paging occasion of the second communication. Stated differently, the second time pattern parameter may be determined to include or take into account the paging occasion scheduled by the second network node. For example, the wireless device may determine the second time pattern parameter to characterize a time pattern which coincides active time periods with one or more paging slots allocated to the wireless device from the second network node or the second network node is configured to schedule the paging slots to match the active periods characterized by the second time pattern parameter received from the wireless device.

In one or more exemplary steps, the method 100 comprises determining S108 additional time pattern parameters indicative of additional communication with an additional network node of the plurality of networks based on one or more of: a type of service associated with the additional network node, a RACH parameter of the additional communication, one or more paging occasions of the additional communication, and a buffer time parameter. The additional network node may be different from the first network node and the second network node. The additional network node may refer to a third network node, e.g. third network node 400B of FIG. 1.

In one or more exemplary methods, determining S102 the first time pattern parameter and the second time pattern parameter comprises determining S102G the first time pattern parameter and/or the second time pattern parameter based on one or more parameters related to one or more additional networks of the plurality of networks. The additional networks may be different from the first network and/or the second network. In one or more exemplary methods, the one or more parameters related to one or more additional networks comprise one or more of: a type of service of a corresponding additional network, a RACH parameter for a corresponding additional network node, one or more paging occasions for the corresponding additional network node, and a buffer time parameter. A buffer time may be a time period between the active periods in the two time patterns to allow the wireless device to switch between a first time pattern and a second time pattern. In other words, any of the first time pattern parameter and the second time pattern parameter may be determined based one or more parameters related to networks other than the first network and the second network respectively, e.g. one or more of: one or more of a corresponding type of service, a corresponding RACH parameter, one or more corresponding paging occasions.

Method 100 may comprise communicating in uplink according to a scheduling grant from the first network node, wherein the scheduling grant is based on the first time pattern parameter. The first network node may be configured to determine the scheduling grant based on the first time pattern parameter.

Method 100 may comprise communicating in uplink according to a scheduling grant from the second network node, wherein the scheduling grant is based on the second time pattern parameter. The second network node may be configured to determine the scheduling grant based on the second time pattern parameter.

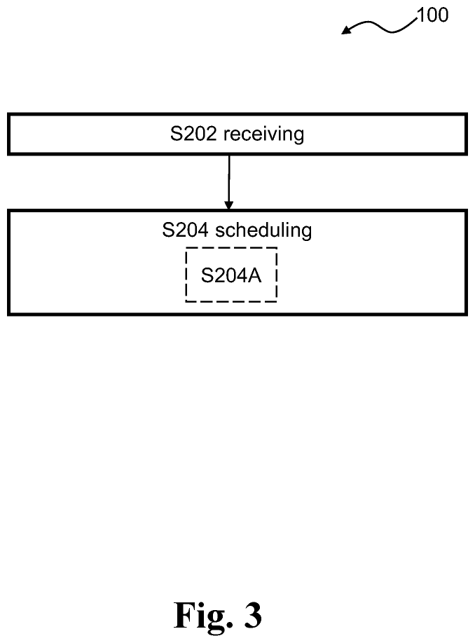

FIG. 3 shows a flow-chart illustrating an exemplary method 200, performed by a network node.

Method 200 is performed by a network node (such as the network node disclosed herein, e.g. network node 400, 400A, 400B of FIGS. 1 and 5). The method 200 comprises receiving S202 from a wireless device (e.g. wireless device 300 of FIGS. 1 and 4), a request comprising a time pattern parameter indicative of a communication with the wireless device.

The method 200 comprises scheduling S204 the communication with the wireless device based on the time pattern parameter.

In one or more exemplary methods, scheduling S204 the communication with the wireless device based on the time pattern parameter comprises scheduling S204A the communication with the wireless device based on the time pattern parameter and based on one or more of: a paging parameter associated with the wireless device, and a RACH parameter associated with the wireless device, and optionally a buffer time parameter.

The method 200 allows the network node to be informed by the wireless device on the time pattern determined by the wireless device, so that the network node (e.g. a scheduler in the RAN) is capable of determining when to allocate time slots for the wireless device to transmit during periods where the wireless device has indicated by the time pattern parameter that it plans to communicate to the network node.

This may advantageously lead to the network nodes being capable of determining paging slots to match the active periods in the time pattern of the wireless devices.

FIG. 4 shows a block diagram of an exemplary wireless device 300 according to the disclosure. The wireless device 300 comprises a memory module 301, a processor module 302, and a wireless interface 303. The wireless interface 303 comprises a radio transceiver 303A, such as a single radio transceiver. The wireless device 300 may be configured to perform any of the methods disclosed in FIG. 2.

The wireless device 300 is configured to communicate with a network node, such as a first network node of a first network and a second network node of a second network disclosed herein, using a wireless communication system (as illustrated in FIG. 1). The single radio transceiver 303A is configured to communicate with the first network node and the second network node via a wireless communication system, such as a 3GPP system.

The wireless device 300 is configured to determine, via the processor module 302 (e.g. via a determiner module 302A), a first time pattern parameter indicative of a first communication with the first network node, and a second time pattern parameter indicative of a second communication with the second network node.

The wireless device 300 is configured to, via the processor module 302 and the radio transceiver 303A, request to the first network node that the first communication is scheduled based on the first time pattern parameter; and to request, via the processor module 302 and the radio transceiver 303A, to the second network node that the second communication is scheduled based on the second time pattern parameter. In one or more exemplary wireless devices, the wireless interface 303 comprises a single radio transceiver 303A.

The wireless device 300 may be configured to, via the processor module 302, generate a first request comprising the first time pattern parameter.

The wireless device 300 may be configured to, via the wireless interface 303 and the radio transceiver 303A, transmit the first request to the first network node.

The wireless device 300 may be configured to, via the processor module 302, generate a second request comprising the second time pattern parameter.

The wireless device 300 may be configured to, via the wireless interface 303 and the radio transceiver 303A, transmit the second request to the second network node.

The processor module 302 is optionally configured to perform any of the operations disclosed in FIG. 2, e.g. any one or more of S102A, S102B, S102C, S102D, S102E, S102F, S102G, S104A, S104B, S106A, S106B, and S108. The operations of the wireless device 300 may be embodied in the form of executable logic routines (e.g., lines of code, software programs, etc.) that are stored on a non-transitory computer readable medium (e.g., the memory module 301) and are executed by the processor module 302).

Furthermore, the operations of the wireless device 300 may be considered a method that the wireless device is configured to carry out. Also, while the described functions and operations may be implemented in software, such functionality may as well be carried out via dedicated hardware or firmware, or some combination of hardware, firmware and/or software.

The memory module 301 may be one or more of a buffer, a flash memory, a hard drive, a removable media, a volatile memory, a non-volatile memory, a random access memory (RAM), or other suitable device. In a typical arrangement, the memory module 301 may include a non-volatile memory for long term data storage and a volatile memory that functions as system memory for the processor module 302. The memory module 301 may exchange data with the processor module 302 over a data bus. Control lines and an address bus between the memory module 301 and the processor module 302 also may be present (not shown in FIG. 4). The memory module 301 is considered a non-transitory computer readable medium.

FIG. 5 shows a block diagram of an exemplary network node 400 according to the disclosure. The network node 400 comprises a memory module 401, a processor module 402, and a wireless interface 403. The network node 400 may be configured to perform any of the methods disclosed in FIG. 3.

The network node 400 is configured to communicate with a wireless device, such as wireless device 300 disclosed herein, using a wireless communication system (as illustrated in FIG. 1). The wireless interface 403 is configured to communicate with the wireless device via a wireless communication system, such as a 3GPP system.

The network node 400 is configured to, via the wireless interface 403, a request comprising a time pattern parameter indicative of a communication with the wireless device.

The network node 400 is configured to schedule, via the processor module 402 (e.g. via a scheduler module 402A), the communication with the wireless device based on the time pattern parameter.

The network node 400 may be configured to, via the wireless interface 403, transmit a response to the wireless device to provide scheduling grant(s).

The processor module 402 is optionally configured to perform any of the operations disclosed in FIG. 3, e.g. S204A. The operations of the network node 400 may be embodied in the form of executable logic routines (e.g., lines of code, software programs, etc.) that are stored on a non-transitory computer readable medium (e.g., the memory module 401) and are executed by the processor module 402).

Furthermore, the operations of network node 400 may be considered a method that the wireless device is configured to carry out. Also, while the described functions and operations may be implemented in software, such functionality may as well be carried out via dedicated hardware or firmware, or some combination of hardware, firmware and/or software.

The memory module 401 may be one or more of a buffer, a flash memory, a hard drive, a removable media, a volatile memory, a non-volatile memory, a random access memory (RAM), or other suitable device. In a typical arrangement, the memory module 401 may include a non-volatile memory for long term data storage and a volatile memory that functions as system memory for the processor module 402. The memory module 401 may exchange data with the processor module 402 over a data bus. Control lines and an address bus between the memory module 401 and the processor module 402 also may be present (not shown in FIG. 5). The memory module 401 is considered a non-transitory computer readable medium.

Embodiments of methods and products (network node and wireless device) according to the disclosure are set out in the following items:

1. A method, performed by a wireless device, for multiple communications between the wireless device and a plurality of network nodes of a plurality of networks, the plurality of network nodes comprising a first network node of a first network and a second network node of a second network, the wireless device comprising a wireless interface with a single radio transceiver configured to communicate with the first network node and the second network node, the method comprising:
determining (S102), a first time pattern parameter indicative of a first communication with the first network node, and a second time pattern parameter indicative of a second communication with the second network node;
requesting (S104), via the single radio transceiver, to the first network node that the first communication is scheduled based on the first time pattern parameter; and
requesting (S106), via the single radio transceiver, to the second network node that the second communication is scheduled based on the second time pattern parameter.

2. The method according to item 1, wherein requesting (S104) to the first network node that the first communication is scheduled based on the first time pattern parameter comprises:
generating (S104A) a first request comprising the first time pattern parameter, and
transmitting (S104B), via the single radio transceiver, the first request to the first network node.

3. The method according to any of the previous items, wherein requesting (S106) to the second network node that the second communication is scheduled based on the second time pattern parameter comprises:
generating (S106A) a second request comprising the second time pattern parameter, and
transmitting (S106B), via the single radio transceiver, the second request to the second network node.

4. The method according to any of the previous items, wherein determining (S102) the first time pattern parameter indicative of the first communication with the first network node is performed (S102A) based on a type of service of the first communication.

5. The method according to any of the previous items, wherein determining (S102) the second time pattern parameter indicative of the second communication with the second network node is performed (S102B) based on a type of service of the second communication.

6. The method according to any of the previous items, wherein determining (S102) the first time pattern parameter indicative of the first communication with the first network node is performed (S102C) based on a random access control channel, RACH, parameter of the first communication.

7. The method according to any of the previous items, wherein determining (S102) the second time pattern parameter indicative of the second communication with the second network node is performed (S102D) based on a random access control channel, RACH, parameter of the second communication.

8. The method according to any of the previous items, wherein determining (S102) the first time pattern parameter indicative of the first communication with the first network node is performed (S102E) based on a paging occasion of the first communication.

9. The method according to any of the previous items, wherein determining (S102) the second time pattern parameter indicative of the second communication with the second network node is performed (S102F) based on a paging occasion of the second communication.

10. The method according to any of the previous items, the method comprising:
determining (S108) additional time pattern parameters indicative of additional communication with an additional network node of the plurality of networks based on one or more of: a type of service associated with the additional network node, a RACH parameter of the additional communication, one or more paging occasions of the additional communication, and a buffer time parameter.

11. The method according to any of the previous items, wherein determining (S102) the first time pattern parameter and the second time pattern parameter comprises determining (S102G) the first time pattern parameter and/or the second time pattern parameter based on one or more parameters related to one or more additional networks of the plurality of networks, wherein the one or more parameters comprise one or more of: a type of service of a corresponding additional network, a RACH parameter for a corresponding additional network node, one or more paging occasions for the corresponding additional network node, and a buffer time parameter.

12. A method, performed by a network node, the method comprising:
receiving (S202), from a wireless device, a request comprising a time pattern parameter indicative of a communication with the wireless device, and
scheduling (S204) the communication with the wireless device based on the time pattern parameter.

13. The method according to item 12, wherein scheduling (S204) the communication with the wireless device based on the time pattern parameter comprises scheduling (S204A) the communication with the wireless device based on the time pattern parameter and based on one or more of: a paging parameter associated with the wireless device, and a RACH parameter associated with the wireless device.

14. A wireless device (300) comprising a memory module (301), a processor module (302), and a wireless interface (303) comprising a radio transceiver (303A), wherein the wireless device is configured to perform any of the methods according to items 1-11.

15. A network node (400) comprising a memory module (401), a processor module (402), and a wireless interface (403), wherein the network node is configured to perform any of the methods according to items 12-13.

16. A computer readable storage medium storing one or more programs, the one or more programs comprising instructions, which when executed by a wireless device cause the wireless device to perform any of the methods of items 1-11.

17. A computer readable storage medium storing one or more programs, the one or more programs comprising instructions, which when executed by a network node cause the network node to perform any of the methods of items 12-13.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-5 comprises some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications, and equivalents.

1. A method, performed by a wireless device, for multiple communications between the wireless device and a plurality of network nodes of a plurality of networks, the plurality of network nodes comprising a first network node of a first network and a second network node of a second network, the wireless device comprising a wireless interface with a single radio transceiver configured to communicate with the first network node and the second network node, the method comprising:
determining, a first time pattern parameter indicative of a first communication with the first network node, and a second time pattern parameter indicative of a second communication with the second network node;
requesting, via the single radio transceiver, to the first network node that the first communication is scheduled based on the first time pattern parameter; and
requesting, via the single radio transceiver, to the second network node that the second communication is scheduled based on the second time pattern parameter.

2. The method according to claim 1, wherein requesting to the first network node that the first communication is scheduled based on the first time pattern parameter comprises:
generating a first request comprising the first time pattern parameter, and
transmitting, via the single radio transceiver, the first request to the first network node.

3. The method according to claim 1, wherein requesting to the second network node that the second communication is scheduled based on the second time pattern parameter comprises:
generating a second request comprising the second time pattern parameter, and
transmitting, via the single radio transceiver, the second request to the second network node.

4. The method according to claim 1, wherein determining the first time pattern parameter indicative of the first communication with the first network node is performed based on a type of service of the first communication.

5. The method according to claim 1, wherein determining the second time pattern parameter indicative of the second communication with the second network node is performed-based on a type of service of the second communication.

6. The method according to claim 1, wherein determining the first time pattern parameter indicative of the first communication with the first network node is performed based on a random access control channel, RACH, parameter of the first communication.

7. The method according to claim 1, wherein determining the second time pattern parameter indicative of the second communication with the second network node is performed-based on a random access control channel, RACH, parameter of the second communication.

8. The method according to claim 1, wherein determining the first time pattern parameter indicative of the first communication with the first network node is performed based on a paging occasion of the first communication.

9. The method according to claim 1, wherein determining the second time pattern parameter indicative of the second communication with the second network node is performed-based on a paging occasion of the second communication.

10. The method according to claim 1, wherein determining the first time pattern parameter and the second time pattern parameter comprises determining the first time pattern parameter and/or the second time pattern parameter based on one or more parameters related to one or more additional networks of the plurality of networks, wherein the one or more parameters comprise one or more of: a type of service of a corresponding additional network, a RACH parameter for a corresponding additional network node, one or more paging occasions for the corresponding additional network node, and a buffer time parameter.

11. A method, performed by a network node, the method comprising:
receiving, from a wireless device, a request comprising a time pattern parameter indicative of a communication with the wireless device, and
scheduling the communication with the wireless device based on the time pattern parameter.

12. The method according to claim 11, wherein scheduling the communication with the wireless device based on the time pattern parameter comprises scheduling the communication with the wireless device based on the time pattern parameter and based on one or more of: a paging parameter associated with the wireless device, and a RACH parameter associated with the wireless device.

13. A wireless device comprising a memory module, a processor module, and a wireless interface comprising a radio transceiver, wherein the wireless device is configured to perform the method of claim 1.

14. A network node comprising a memory module a processor module, and a wireless interface, wherein the network node is configured to perform the method of claim 11.

15. A non-transitory computer readable storage medium storing one or more programs, the one or more programs comprising instructions, which when executed by a wireless device cause the wireless device to perform the method of claim 1.
